(19) United States
(12) Patent Application Publication
(10) Pub. No.: US 2012/0017441 A1
(43) Pub. Date: Jan. 26, 2012

(54) COMBINATION DUAL BLADE KNIFE

(76) Inventor: Artem Kalajyan, Burbank, CA (US)

(21) Appl. No.: 13/189,267

(22) Filed: Jul. 22, 2011

Related U.S. Application Data
(60) Provisional application No. 61/366,876, filed on Jul. 22, 2010.

(51) Int. Cl. B26B 1/00

(52) U.S. Cl. 30/152

(57) ABSTRACT

A knife is provided. The knife comprises a handle and a utility blade mounted to a blade holder, the blade holder mounted to the handle and configured to move relative to the handle between a retracted position, in which the utility blade does not extend from the handle, and an extended position, in which the utility blade extends from the handle in an operative position. The knife further comprises a tanto-style blade mounted to the handle and configured to move relative to the handle between a closed position, in which a cutting edge of the tanto-style blade does not extend from the handle, and an open position, in which the tanto-style blade extends from the handle in an operative position.

### CLAIM OF PRIORITY UNDER 35 U.S.C. §119

The present Application for patent claims benefit of U.S. Provisional Patent Application Ser. No. 61/366,876 filed Jul. 22, 2010, entitled, “Combination Drywall Dual Blade Knife” which is hereby expressly incorporated by reference herein.

### BACKGROUND OF THE INVENTION

1. Field of the Invention

Embodiments of the present invention generally relate to hand tools, and more specifically to a combination drywall knife having dual blades.

2. Description of the Related Art

Conventional folding knives have different blades for different uses. For example, a knife may be configured with a utility blade mounted to a blade holder. This type of knife typically provides for easy replacement of the utility blade, and is useful in applications where significant blade wear is expected. Cutting and coring drywall is one such application. When the utility blade is dulled or damaged, the user can easily replace the utility blade with a sharp and undamaged utility blade. The low cost of replacement utility blades allows for frequent changing of blades, as needed. However, utility blades are not strong enough for heavy duty applications. Furthermore, utility blades do not have sufficient length for certain applications. For example, a utility blade is not suitable for puncturing a hole in drywall because it is not strong enough or long enough.

A combination knife with a utility blade that extends from one end and a sporting blade that pivots from the other end is disclosed in U.S. Pat. No. 7,739,799, which is hereby incorporated by reference in its entirety. However, this arrangement does not provide for two folding blades in one knife where both blades are suitable for a single, general application such as cutting drywall in which scoring drywall and puncturing drywall may be necessary. Furthermore, the arrangement provides for the two blades to be deployed from opposite ends of the handle, so that a user must reverse his or her grip on the handle when alternating from using one blade to using the other.

### SUMMARY OF THE INVENTION

According to aspects of the present aspects, a knife is provided. The knife comprises a handle and a utility blade mounted to a blade holder, the blade holder mounted to the handle and configured to move relative to the handle between a retracted position, in which the utility blade does not extend from the handle, and an extended position, in which the utility blade extends from the handle in an operative position. The knife further comprises a tanto-style blade mounted to the handle and configured to move relative to the handle between a closed position, in which a cutting edge of the tanto-style blade does not extend from the handle, and an open position, in which the tanto-style blade extends from the handle in an operative position.

According to additional aspects of the present application, a knife is provided. The knife may comprise a handle having a first end and a second end. The knife may further comprise a first blade removably mounted to a blade holder, the blade holder mounted to the handle and configured to move relative to the handle between a retracted position, in which the first blade does not extend from the handle, and an extended position, in which the first blade extends from the first end in an operative position. The knife may further comprise a second blade mounted to the handle and configured to move relative to the handle between a closed position, in which a cutting edge of the second blade does not extend from the handle, and an open position, in which the second blade extends from the first end in an operative position, wherein the second blade is a work blade not removably mounted to a blade holder.

According to additional aspects of the present application, a knife is provided. The knife may comprise a handle having a first end and a second end, wherein the first end comprises a first opening and a second opening. The knife may further comprise a first blade mounted to a blade holder, the blade holder mounted to the handle and configured to move relative to the handle between a retracted position, in which the first blade does not extend from the handle and an extended position, in which the first blade extends from the first opening in an operative position. The knife may further comprise a second blade mounted to the handle and configured to move relative to the handle between a closed position, in which a cutting edge of the second blade does not extend from the handle, and an open position, in which the second blade extends from the second opening in an operative position.

According to additional aspects of the present application, a knife is provided. The knife may comprise a handle and a first blade mounted to a blade holder, the blade holder mounted to the handle and configured to pivotally move relative to the handle between a retracted position, in which a cutting edge of the first blade does not extend from the handle, and an extended position, in which the first blade extends from the handle in an operative position. The knife may further comprise a second blade mounted to the handle and configured to move relative to the handle between a closed position, in which a cutting edge of the second blade does not extend from the handle, and an open position, in which the second blade extends from the handle in an operative position. The first blade may be a utility blade removably mounted to the blade holder. The second blade may be a work blade not removably mounted to a blade holder.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a side view of a knife with a utility blade extended in an operative position and a work blade partially rotated towards an operative position according to certain embodiments of the present invention.

FIG. 2 illustrates a side view of the knife with the utility blade and the work blade both in closed.

FIG. 3 illustrates a side view of the knife with the utility blade extended in an operative position and the work blade in a closed position.

FIG. 4 illustrates a side view of the knife with the utility blade in a closed position and the work blade in an operative position.

FIG. 5A illustrates a bottom view of the knife with the utility blade extended in an operative position and the work blade in a closed position.

FIG. 5B illustrates a detail of a cross-section view of the knife with the utility blade in a closed position and the work blade extended in an operative position.

FIG. 6 illustrates a side view of a knife with a utility blade and a work blade both in closed positions, according to an embodiment of the present invention.

FIG. 7 illustrates a side view of the knife with the utility blade in the closed position and the work blade in an operative position.

FIG. 8 illustrates a top view of the knife with the utility blade in the closed position and the work blade in the operative position.

FIG. 9A illustrates a cross-section view of the knife with a blade lock of the work blade in a lock position.

FIG. 9B illustrates a cross-section view of a knife with the blade lock of the sliding work blade in an unlock position.

FIG. 10 illustrates a perspective view of a frame of the knife and a work blade slide lock mechanism.

FIG. 11 illustrates a perspective view of the frame of the knife and a blade holder.

FIG. 12 illustrates a view of the blade holder with a utility blade lock mechanism.

### DETAILED DESCRIPTION

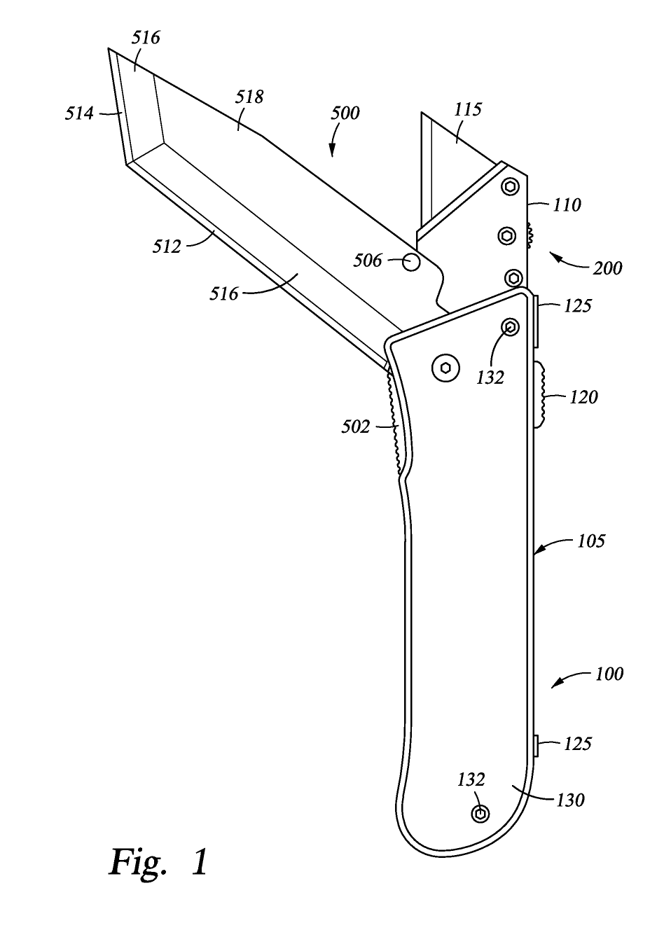

Referring specifically to the Figures in which identical or similar parts as designated by the same reference numerals throughout, and further referring to FIG. 1, the knife in accordance with the present invention is generally designated by reference numeral 100.

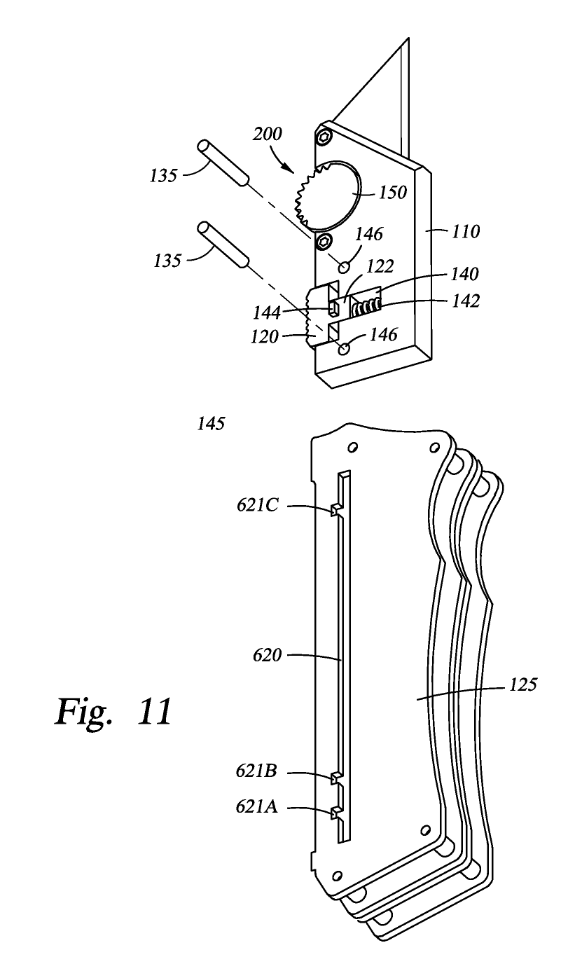

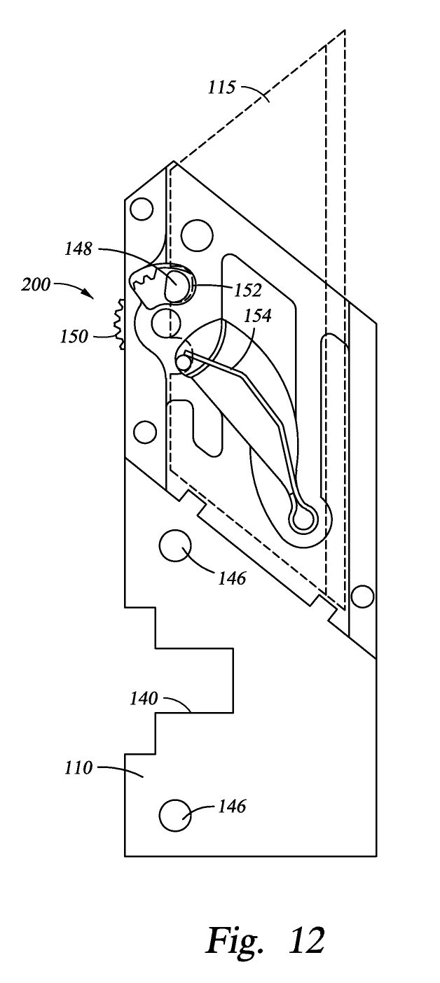

FIG. 1 is a side view of the knife 100 according to certain embodiments to the present invention. The knife 100 includes a handle 105. The handle 105 may be comprised of a frame 125 and handle covers 130. Handle covers 130 may be secured to frame 125 via screws 132 or other suitable fastening mechanism. The knife 100 further includes a utility blade 115 mounted in a blade holder 110. A utility blade lock mechanism 200 is mounted to the blade holder 110. The blade holder 110 and utility blade lock mechanism 200 is described in further detail below, with respect to FIGS. 11 and 12.

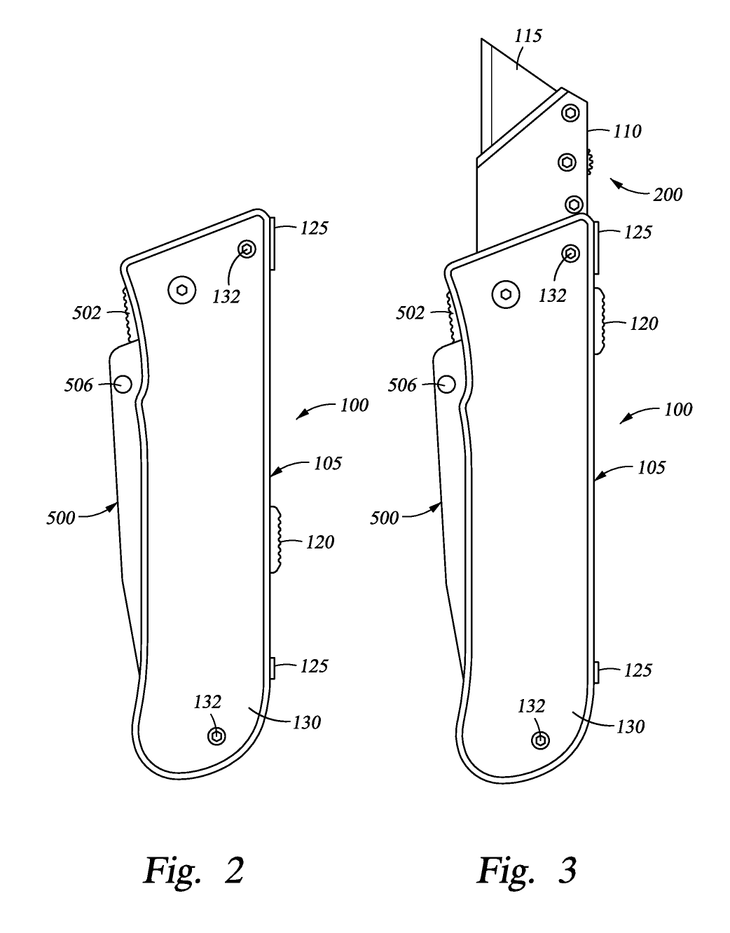

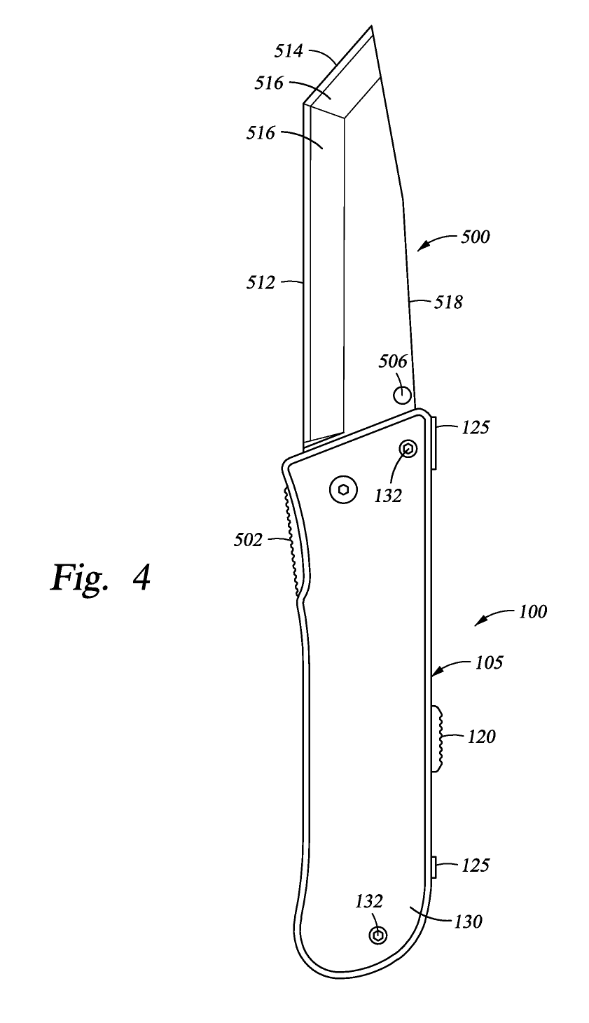

The blade holder 110 is movable with respect to the handle 105 between a retracted position and an extended position. The extended position is an operative position. FIGS. 1, 3 and 5 illustrate the knife 100 with the blade holder 110 in the extended position. FIGS. 2 and 4 illustrate the knife 100 with the blade holder 110 in the retracted position. In some embodiments, the blade holder 110 is also movable to one or more intermediate positions between the retracted position and the extended position. The blade holder 110 may extend from the handle 105 in the extended position. The one or more intermediate positions may be operative positions. According to some embodiments, the blade holder 110 may extend from the handle 105 in an intermediate, operative position. According to alternative embodiments, the blade holder 110 may not extend from the handle in an intermediate, operative position.

A button 120 is mounted on the blade holder 110. Generally, the button 120 is used to move the blade holder 110 relative to the handle 105. The button 120 is also used to unlock the blade holder 110 in the retracted position, the extended position, and the one or more intermediate positions. According to some embodiments, the blade holder 110 with utility blade 115 can be moved between the retracted position, intermediate positions and the extended position by the user's thumb on the hand that is holding the knife 100. In other words, in some embodiments, the configuration of the handle 105, blade holder 110, and button 120 may provide for one-handed operation of moving the blade holder 110 with utility blade 115 between the different positions.

In the embodiment shown, the blade holder 110 telescopically moves between the retracted position and the extended position. In an alternative embodiment, the blade holder 110 may pivotally move between the retracted position and the extended position. In such an embodiment, a portion of the blade holder 110 and the cutting edge of the utility blade 115 may be disposed within the handle when the blade holder 110 is in the retracted position. However, in the alternative embodiment, other portions of the blade holder 110 and/or utility blade 115 may extend from the handle when the blade holder 110 is in the retracted position. Thus, while the blade holder 110 is in the retracted position, the cutting edge of the utility blade 115 is covered to protect a user, while a portion of the blade holder 110 is accessible to the user for pivotally moving the blade holder 110 to the extended, operative position. In the alternative embodiment in which the blade holder 110 pivotally moves between the retracted position and the extended position, the blade holder includes suitable structure for pivotal movement, such as disclosed below with respect to work blade 500 shown in FIGS. 1-5B, or other structures known in the art for pivotal movement of a blade holder.

The knife 100 also includes work blade 500. The work blade 500 may be any suitable blade shape—such as, for example, a tanto-style blade, a saw blade or a sporting-type blade—for use in combination with the blade holder 110 with utility blade 115. For some embodiments, such as for use in puncturing drywall, the tanto-style blade may be suitable. A cutting edge of the work blade 500 may be partially serrated. In the embodiments illustrated, the work blade 500 is a tanto-style blade, which includes a first linear cutting edge 512 and a second linear cutting edge 514. The first linear cutting edge 512 and the second linear cutting edge 514 form an obtuse angle near the forward point of the work blade 500. The work blade 500 also includes a bevel transition 516 between the central portion 518 of the blade, which is relatively thick, and the cutting edges 512 and 514. The dull edge of the work blade 500 opposite the cutting edges 512 and 514 may be comprised of one or more linear edges. For example, in the embodiment shown in FIGS. 1 and 4, the dull edge is comprised of a first linear edge and a second linear edge, with the second linear edge intersecting the second linear cutting edge 514 to form the forward point of the work blade 500.

In the embodiment described above, the tanto-style shape of the work blade 500 provides a high level of blade strength, particularly with respect to loads applied at and near the forward point. Thus, in some embodiments, the work blade 500 is highly suitable for heavy duty applications requiring the puncturing of various materials. For example, the work blade 500 may be highly effective at puncturing drywall without risk of the work blade 500 breaking. Accordingly, the combination of the work blade 500 with the utility blade 115 in a single knife 100 provides a useful tool for certain applications where puncturing a thick material is required and where cutting and/or scoring the thick material is also required, such as in drywall installation or repair. For example, a user is able to puncture a hole in drywall with the work blade 500 and then cut and/or score the drywall with the utility blade 115, without changing tools or even without changing grip on the knife 100 with the operative hand. As noted, the disclosed knife 100 is not necessarily limited to a work blade 500 having a tanto-style shape described above.

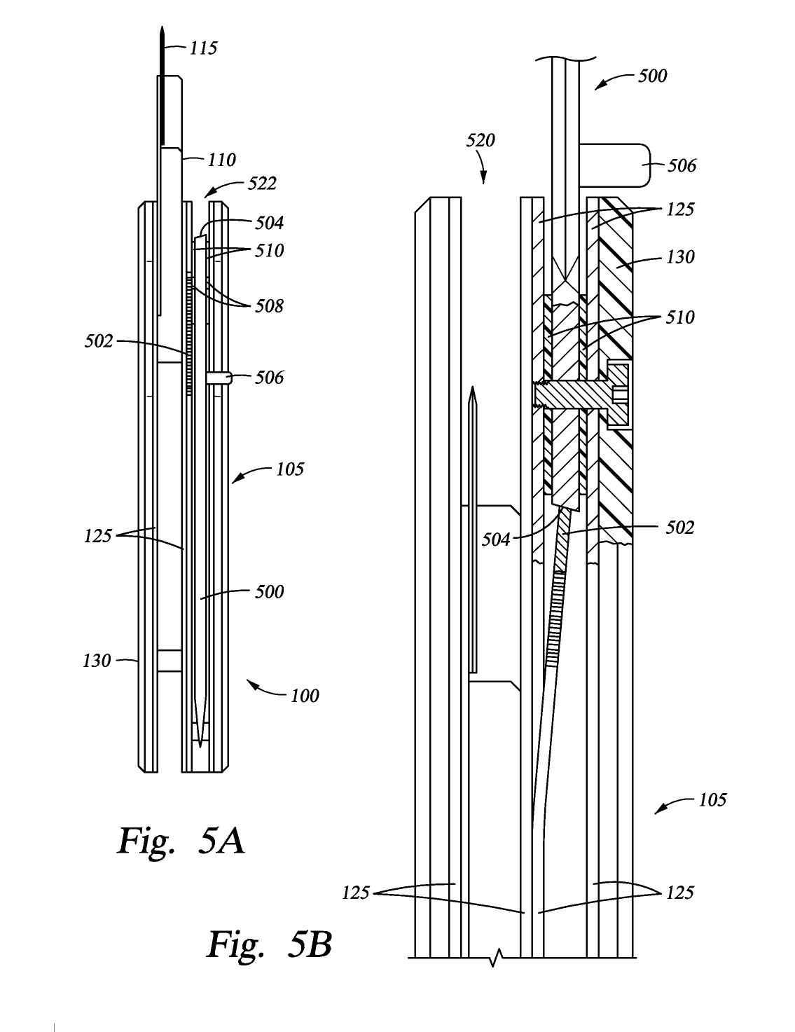

In certain embodiments, such as shown in FIGS. 1-5B, the work blade 500 is configured to pivotally move between a closed position and an open, operative position. FIGS. 2, 3 and 5A illustrate the knife 100 with the work blade 500 in the closed position. FIGS. 4 and 5B illustrate the knife 100 with the work blade 500 in the open position. FIG. 1 illustrates the work blade 500 in an intermediate position (between the open position and the closed position) to more clearly illustrate the two blades of the knife 100. However, the intermediate position of the work blade 500 in FIG. 1 is not contemplated as an operative position. A peg 506 is provided on the work blade 500. The peg 506 allows a user to easily pivot the work blade 500 from the closed position to the open position with the same hand that is holding. For example, the user's thumb on the hand holding the knife 100 can apply a force to the peg 506 to pivotally move the work blade from the closed position to the open position.

FIG. 5A illustrates a bottom view of the knife 100 with the utility blade 115 and blade holder 110 extended in an operative position and the work blade 500 in a closed position, according to certain embodiments of the present invention. FIG. 5B illustrates a detail of a cross-section view (from the bottom) of the knife 100 with the work blade 500 in an operative position and the utility blade 115 and blade holder 110 disposed in the handle 105 in a retracted position. As can be seen in FIGS. 5A and 5B, the utility blade 115 and blade holder 110 extend from the front of the handle 105 through opening 520, and the work blade 500 extends from the front of the handle 105 through opening 522. In some embodiments, this arrangement may allow one of the blades to extend through its respective opening without being soiled from residual material that has collected on the other opening.

A pair of spacers 510 provides clearance for the work blade 500 with respect to the interior of the handle 105. In some embodiments, the work blade 500 is mounted between the frame 125 on the interior portion of the knife 100 and a handle cover 130 on the exterior side. The pair of spacers 510 may also provide for smooth pivotal movement of the work blade 500. A pre-bent leaf spring 502 is disposed inside the handle and is biased toward the work blade 500. As shown in FIG. 5B, when the work blade 500 is in the open position, the leaf spring 502 engages a canted surface 504 on the end of the work blade 500 opposite the forward point. When the leaf spring 502 is engaged with canted surface 504, the work blade 500 is locked in the open position and prevented from pivoting to the closed position. To unlock the blade, a user overcomes the biasing force of the leaf spring 502 by applying a force in a direction away from the work blade 500, causing the leaf spring 502 to disengage from canted surface 504. The force may be applied with the user's thumb on the hand that is holding the knife 100. The work blade 500 can then be pivotally moved to the closed position.

A blade stop 508 is disposed in the handle 105. When the work blade 500 is in the closed position, the blade stop 508 abuts a surface on the work blade 500 and prevents the work blade 500 from pivoting further into the handle. When the work blade 500 is in the open position, the blade stop 508 abuts another surface on the work blade 500. Thus, when the blade 500 is in the open position, the blade stop 508 prevents the work blade 500 from over-pivoting beyond the open position. The biasing force of the leaf spring 502 may also urge the work blade 500 against the blade stop 508, thereby securing the work blade 500 into the open, operative position.

In some embodiments, the user may use the same hand that is holding the knife 100 to pivotally move the work blade from the open position to the closed position. In other words, in some embodiments, the configuration of the work blade 500, the leaf spring 502, the peg 506, and the handle 105 may provide for one-handed operation of pivotally moving the work blade 500 between the open, locked position and the closed position. Once the work blade 500 has been moved out of the open position, i.e., into an intermediate position such as shown in FIG. 1, the user may release the force being applied to the leaf spring 502 for unlocking the work blade 500, and the work blade 500 is still free to pivotally move with respect to the handle 105 because the leaf spring 502 will no longer engage canted surface 504.

In FIG. 1, it can be seen that the work blade 500 and the blade holder 110 with utility blade 115 extend into their respective operative positions on the same end of the handle 105. Furthermore, as noted, both the work blade 500 and the blade holder 110 with utility blade 115 may be moveable from their respective closed positions to their respective open, operative positions with a single hand of the user. In other words, according to embodiments of the present application, deploying either blade to an operative position and back to a closed position can be accomplished with a single hand of the user. Furthermore, according to some embodiments, the handle 105 is ergonomically shaped for ease of grip by the user's hand, which may allow the user to deploy either blade between their respective closed positions to their respective open, operative positions, as desired, without significant adjustment to his or her operative grip on the handle 105. For example, the user may not need to change the direction of the handle 105 when the user desires to change from the work blade 500 to the utility blade 115 or vice versa.

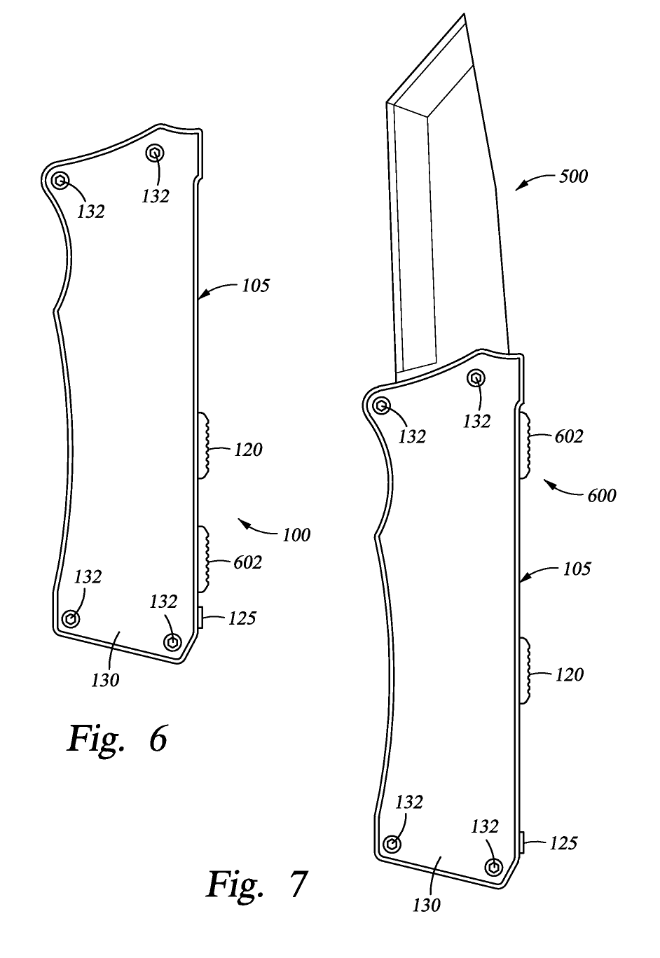

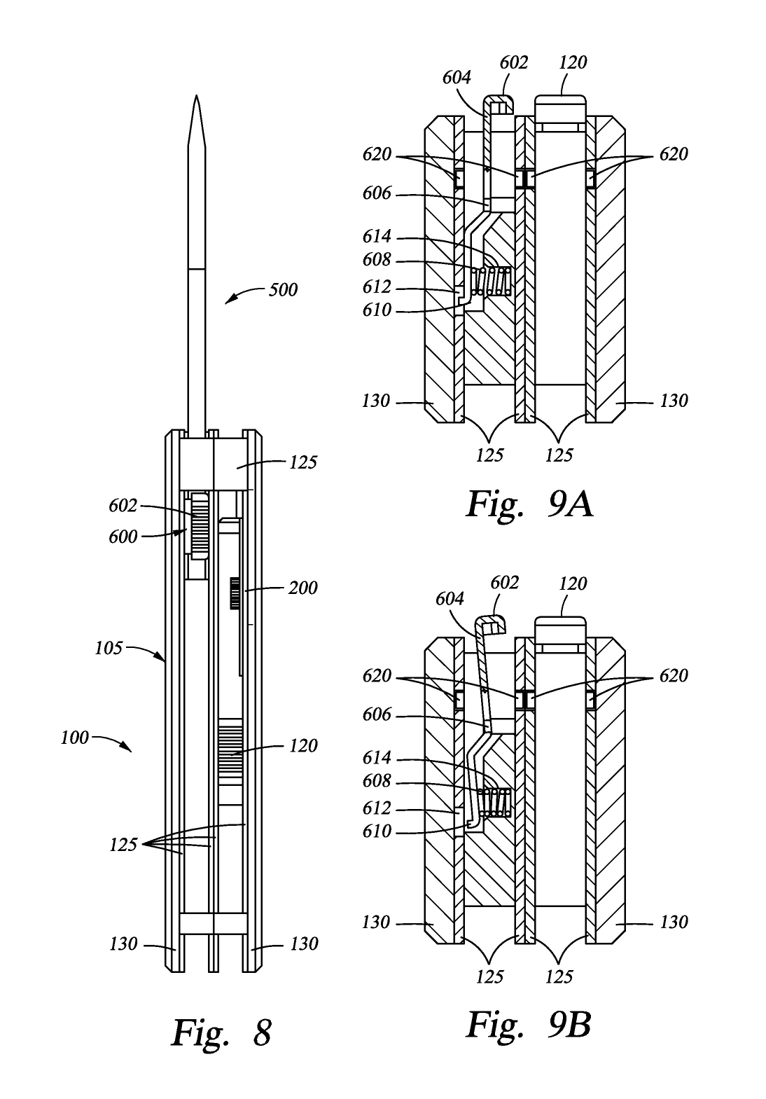

In certain embodiments, such as shown in FIGS. 6-10, the work blade 500 may be configured to telescopically move relative to the handle 105 between a closed position and an open, operative position. FIG. 6 illustrates the knife 100 with the work blade 500 in the closed position. FIGS. 7 and 8 illustrate the knife 100 with the work blade 500 in the open position.

FIGS. 9A and 9B illustrate one embodiment of a slide lock mechanism 600. The slide lock mechanism 600, which includes a button 602, is operatively connected to the work blade 500. The button 602 is disposed on pivoting member 604, which also includes pivot flanges 606 and protrusion 610. A spring 608 is disposed in cavity 614. As shown in FIG. 9A, a biasing force from the spring 608 urges protrusion 610 into cut-out 612 formed in the frame 125, locking the work blade in place. According to some embodiments, there are two cut-outs 612, corresponding to the closed position and the open, operative position, respectively. According to alternate embodiments, there may be one or more additional cut-outs 612 corresponding to one or more intermediate operative positions. As shown in FIG. 9B, when a force is applied to the button 602 to overcome the biasing force, protrusion 610 is moved out of cut-out 612 and the work blade 500 is free to slide between the closed position and the open, operative position.

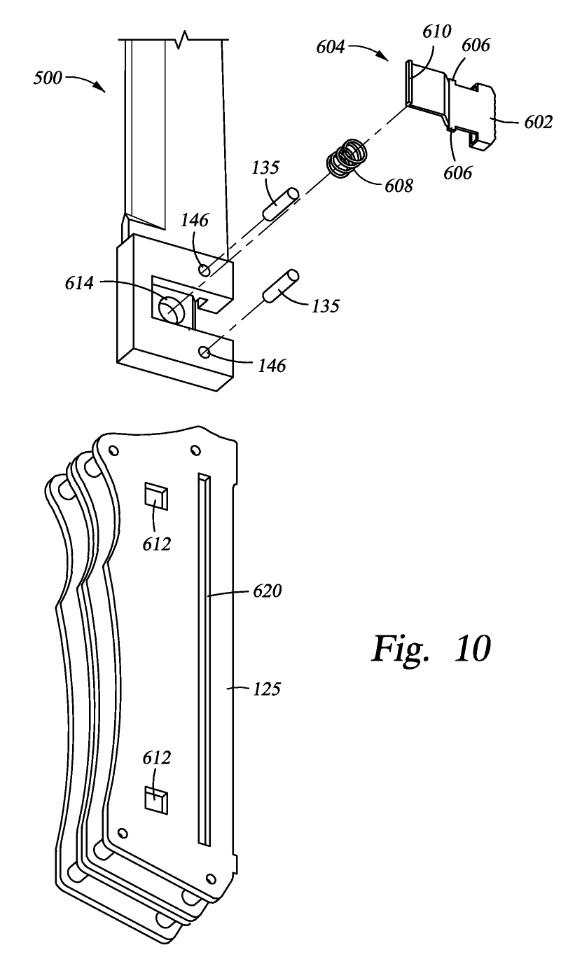

As illustrated in FIG. 10, guide pins 135 are disposed in holes 146. The guide pins 135 extend from both lateral sides of slide lock mechanism 600 and into guide slots 620 in frame 125. In some embodiments, the guide pins 135 may provide for smooth movement between the closed position and the open, operative position. The present disclosure is not limited to the guide pins 135 shown. For example, in some embodiments, other rolling members such as ball bearings may be disposed between the slide lock mechanism 600 and the guide slots 620.

FIGS. 11 and 12 illustrate an embodiment of the blade holder 110 and utility blade lock mechanism 200. The utility blade lock mechanism 200 includes rotatable member 150 pivotally movable between a locked position, in which a protrusion 148 engages a mounting notch 152 in utility blade 115 (shown in phantom in FIG. 12), and an unlocked position, in which the protrusion 148 does not engage the mounting notch 152 in utility blade 115. The rotatable member 150 is biased towards the locked position by a leaf spring 154 or other suitable biasing member. When the rotatable member 150 is in the locked position, the utility blade 115 is locked to the blade holder. When the rotatable member 150 is rotated to the unlocked position, the utility blade 115 can be removed and replaced. In some uses, the utility blade may be removed, and then the same utility blade 115 is reversed and replaced in the blade holder 110 so that a new portion of the cutting edge is exposed. In some uses, the utility blade 115 is removed and replaced entirely with a new utility blade 115, such as when, for example, the entire cutting edge is dulled or soiled.

Blade holder 110 is provided with a T-shaped slot 140. The button 120, which may be formed of a slip resistant material, such as rubber or rubber-like material, is formed with a downwardly depending post 122 which is disposed in T-shaped slot 140. The button 120 can move downwardly or upwardly within the T-shaped slot 140. A suitable spring 142, such as helical spring, is arranged between the T-shaped slot 140 and the post 122 so that the spring 142 normally biases or urges the release button 120 to move in an upward direction, although a downward pressure on the release button 120 by a user can move the release button downwardly into the T-shaped slot 140 against the action of the spring 142.

As can be seen in FIG. 11, the button 120 includes flanges 144. In some embodiments, flanges 144 may be formed from a separate bar or pin inserted through button 120. The frame 125 includes right and left (not shown) guide slots 620 that extend along the longitudinal axis of the handle 105. Indents 621A, 621B and 621C are provided in the guide slots 620. When the blade holder 110 is disposed in the frame 125, flanges 144 are disposed within the guide slots 620 for sliding movement of the blade holder 110 with respect to the frame 125 and handle 105. The location of the indents 621A, 621B and 621C are selected so that when the spring 142 urges the button 120 upwardly this biases flanges 144 upwardly and, when juxtaposed against one of the indents 621A, 621B and 621C, the flanges 144 will be urged into an indent below which it is placed. It should be evident that once the flanges 144 are received within one of the indents 621A, 621B and 621C, blade holder 110 is locked from longitudinal sliding movements along the axis A of the handle 105. Indent 621A corresponds to the retracted position in which the blade holder 110 and the blade 115 are disposed in the handle 105. Indent 621B may correspond to an intermediate, operative position. Indent 621C corresponds to the extended, operative position.

When the button 120 is pressed downwardly, against the action of the spring 142, the flanges 144 are urged out of an indent in which they have been positioned, at which time a longitudinal or axial force on the button 120 causes the blade holder 110 to slide in the direction of the force applied. In some embodiments, the knife 100 is configured for the user's thumb to conveniently apply the force to button 120.

To facilitate sliding and to stabilize the movements of the blade holder 110 between extended and retracted positions, there are provided holes 146 in the blade holder 110 through which guide pins 135 are disposed, similar to the arrangement described above with respect to FIG. 10. Guide pins 135 are disposed through the blade holder 110 and extend into right and left (not shown) guide slots 620 in frame 125. In some embodiments, the guide pins 135 may roll within guide slots 20 as the blade holder 110 moves relative to the handle 105. In some embodiments, the guide pins 135 may provide for smooth movement of the blade holder between the extended and retracted positions. The present disclosure is not limited to the guide pins 135 shown. For example, in some embodiments, other rolling members such as ball bearings may be disposed between the blade holder 110 and the guide slots 620.

According to some embodiments, the knife 100 may be used for drywall applications. The user holds the knife 100 in one hand with the work blade 500 in the closed position and the utility blade 115 and blade holder 110 in the retracted position. The user may move the work blade 500 to the open, operative position with the same hand. The user may puncture a hole in a work piece—such as a drywall sheet that needs to be cut to a particular shape—with the work blade 500. The user may use the work blade 500 to expand the hole to a desired shape. For example, the work blade 500 may be used to puncture and/or cut a hole to fit a plumbing fixture over which the drywall sheet is to be mounted. As another example, the work blade 500 may be used to puncture and/or cut a hole to fit a hole for an electrical junction box to be installed behind a drywall piece that is already mounted. Following such heavy duty cutting and/or puncturing of the drywall with the work blade 500, the work blade 500 may be moved to the closed position. The user may move the blade holder 110 and utility blade 115 to the extended, operative position. The user may score and/or cut the same or different work piece—such as a drywall sheet that needs to be cut to a particular shape—with the utility blade 115. For example, the user may score the drywall sheet along a predetermined line with the utility blade 115, and the drywall sheet can then easily cleave and separate along the scored, predetermined line. If the utility blade 115 becomes dull or soiled, it may be removed and replaced as described above, and then used for further scoring and/or cutting. Following such scoring or cutting with the utility blade 115, the blade holder 110 and utility blade 115 may be moved to the retracted position. Use of the utility blade 115 and use of the work blade 500 may be in any order or repeated, depending on the needs of a particular job or application. Use of the utility blade 115 and use of the work blade 500 may be accomplished without changing the orientation of the knife 100 in the user's hand. Also, use of the utility blade 115 and use of the work blade 500 may be accomplished without changing the user's grip on the knife in the user's operative hand.

While the foregoing is directed to embodiments of the present invention, other and further embodiments of the invention may be devised without departing from the basic scope thereof, and the scope thereof is determined by the claims that follow.

1. A knife comprising:
a handle;
a utility blade mounted to a blade holder, the blade holder mounted to the handle and configured to move relative to the handle between a retracted position, in which the utility blade does not extend from the handle, and an extended position, in which the utility blade extends from the handle in an operative position; and
a tanto-style blade mounted to the handle and configured to move relative to the handle between a closed position, in which a cutting edge of the tanto-style blade does not extend from the handle, and an open position, in which the tanto-style blade extends from the handle in an operative position.

2. The knife according to claim 1, wherein the tanto-style blade is configured to pivotally move relative to the handle between the closed position and the open position.

3. The knife according to claim 1, wherein the tanto-style blade is configured to telescopically move relative to the handle between the closed position and the open position.

4. The knife according to claim 1, wherein the blade holder is configured to be moved between the retracted position and the extended position by a user's hand while the user's hand is grasping the handle with an operative grip, and the tanto-style blade is configured to be moved between the closed position and the open position by the user's hand while the user's hand is grasping the handle with the operative grip.

5. The knife according to claim 4, further comprising a blade lock mechanism movable between a lock position, in which the utility blade is locked to the blade holder, and an unlock position, in which the utility blade is removable from the blade holder, wherein the blade lock mechanism is configured to be moved between the lock position and the unlock position by the user's hand while the user's hand is grasping the handle with the operative grip.

6. The knife according to claim 1, further comprising at least one rolling member disposed in at least one guide slot in the handle, the at least one rolling member configured to support the blade holder relative to the handle as the blade holder moves between the retracted position and the extended position.

7. The knife according to claim 1, wherein the blade holder extends from the handle when the blade holder is in the extended position.

8. A knife comprising:
a handle having a first end and a second end;
a first blade removably mounted to a blade holder, the blade holder mounted to the handle and configured to move relative to the handle between a retracted position, in which the first blade does not extend from the handle, and an extended position, in which the first blade extends from the first end in an operative position; and
a second blade mounted to the handle and configured to move relative to the handle between a closed position, in which a cutting edge of the second blade does not extend from the handle, and an open position, in which the second blade extends from the first end in an operative position, wherein the second blade is a work blade not removably mounted to a blade holder.

9. The knife according to claim 8, wherein the second blade is configured to pivotally move relative to the handle between the closed position and the open position.

10. The knife according to claim 8, wherein the second blade is configured to telescopically move relative to the handle between the closed position and the open position.

11. The knife according to claim 8, wherein the first blade is configured to be moved between the retracted position and the operative position by a user's hand while the user's hand is grasping the handle with an operative grip, and the second blade is configured to be moved between the closed position and the open position by the user's hand while the user's hand is grasping the handle with the operative grip.

12. The knife according to claim 11, further comprising a blade lock mechanism movable between a lock position, in which the first blade is locked to the blade holder, and an unlock position, in which the first blade is removable from the blade holder, wherein the blade lock mechanism is configured to be moved between the lock position and the unlock position by the user's hand while the user's hand is grasping the handle with the operative grip.

13. The knife according to claim 8, wherein the second blade comprises a first linear cutting edge forming an obtuse angle with a second linear cutting edge, and the second linear cutting edge intersects a dull edge of the second blade to form a forward point of the second blade.

14. The knife according to claim 8, wherein the second blade has a partially serrated cutting edge.

15. The knife according to claim 8, wherein the second blade is a sporting blade.

16. The knife according to claim 8, further comprising at least one rolling member disposed in at least one guide slot in the handle, the at least one rolling member configured to support the blade holder relative to the handle as the blade holder moves between the retracted position and the extended position.

17. A knife comprising:
a handle having a first end and a second end, wherein the first end comprises a first opening and a second opening;
a first blade mounted to a blade holder, the blade holder mounted to the handle and configured to move relative to the handle between a retracted position, in which the first blade does not extend from the handle and an extended position, in which the first blade extends from the first opening in an operative position; and
a second blade mounted to the handle and configured to move relative to the handle between a closed position, in which a cutting edge of the second blade does not extend from the handle, and an open position, in which the second blade extends from the second opening in an operative position.

18. The knife according to claim 17, wherein the second blade is configured to pivotally move relative to the handle between the closed position and the open position.

19. The knife according to claim 17, wherein the first blade is configured to be moved between the retracted position and the operative position by a user's hand while the user's hand is grasping the handle with an operative grip, and the second blade is configured to be moved between the closed position and the open position by the user's hand while the user's hand is grasping the handle with the operative grip.

20. The knife according to claim 19, further comprising a blade lock mechanism movable between a lock position, in which the first blade is locked to the blade holder, and an unlock position, in which the first blade is removable from the blade holder, wherein the blade lock mechanism is configured to be moved between the lock position and the unlock position by the user's hand while the user's hand is grasping the handle with the operative grip.

21. The knife according to claim 17, further comprising at least one rolling member disposed in at least one guide slot in the handle, the at least one rolling member configured to support the blade holder relative to the handle as the blade holder moves between the retracted position and the extended position.

22. A knife comprising:
a handle;
a first blade mounted to a blade holder, the blade holder mounted to the handle and configured to pivotally move relative to the handle between a retracted position, in which a cutting edge of the first blade does not extend from the handle, and an extended position, in which the first blade extends from the handle in an operative position; and
a second blade mounted to the handle and configured to move relative to the handle between a closed position, in which a cutting edge of the second blade does not extend from the handle, and an open position, in which the second blade extends from the handle in an operative position,
wherein the first blade is a utility blade removably mounted to the blade holder and the second blade is a work blade not removably mounted to a blade holder.

23. The knife according to claim 22, wherein the second blade comprises a first linear cutting edge forming an obtuse angle with a second linear cutting edge, and the second linear cutting edge intersects a dull edge of the second blade to form a forward point of the second blade.

24. The knife according to claim 22, wherein the first blade extends from a front end of the handle when the blade holder is in the extended position, and the second blade extends from the front end when the second blade is in the open position.
